(19) United States
(12) Patent Application Publication
(10) Pub. No.: US 2026/0277256 A1
(43) Pub. Date: Sep. 17, 2026

(54) SYSTEMS AND METHODS FOR SOLAR PANEL ARRAY ACTUATION CONTROL

(71) Applicant: Kinematics, LLC, Phoenix, AZ (US)

(72) Inventors: Adam Peter PLESNIAK, Huntington Beach, CA (US); Sean Thomas MACHIN, Scottsdale, AZ (US); Brandon Christopher LARSON, Long Beach, CA (US); Johannes Gerhardus VAN DER HORST, Toronto (CA)

(21) Appl. No.: 19/554,286

(22) Filed: Mar. 2, 2026

Related U.S. Application Data
(63) Continuation of application No. PCT/US2024/045179, filed on Sep. 4, 2024.
(60) Provisional application No. 63/580,650, filed on Sep. 5, 2023.

(51) Int. Cl. G05D 3/10; H02J 13/10; H02J 13/181; H02J 101/22; H02S 20/32

(52) U.S. Cl. CPC G05D 3/105; H02J 13/10; H02J 13/181; H02S 20/32; H02J 2101/22

(57) ABSTRACT

Provided herein are systems and methods for solar panel array actuation control. The system can comprise at least one network controller and one or more solar panel array motion controllers, each solar panel array motion controller being provided to a respective one of one or more solar panel arrays and is in wireless communication with the network controller. Each one of the one or more solar panel arrays can be configured to rotate by an actuation of an actuator under a control of the solar panel array motion controller, based at least on an instruction received by the solar panel array motion controller from the network controller.

### CROSS-REFERENCE

This application is a continuation of International Application No. PCT/US2024/045179, filed Sep. 4, 2024, which claims the benefit of U.S. Provisional Application No. 63/580,650, filed Sep. 5, 2023, each of which is hereby incorporated by reference in its entirety for all purposes.

### BACKGROUND

A solar tracking system or solar tracker is coupled to a solar panel or a plurality of solar panels that are coupled to a common shaft to adjust an inclination angle of the solar panel(s) to align with the Sun as it moves across the sky. The adjustment of the inclination angle increases the amount of electric energy produced from the solar panel(s) as compared to the same panel(s) mounted as fixed-tilt.

### SUMMARY

In one aspect, disclosed herein is a system for solar panel array actuation control. In some embodiments, the system can comprise at least one network controller; and one or more solar panel array motion controllers, each of which is provided to a respective one of one or more solar panel arrays and in wireless communication with the network controller. In some embodiments, each one of the solar panel arrays can comprise (i) a rotational shaft, (ii) one or more solar panels coupled to the rotational shaft and configured to rotate synchronously with the rotational shaft, and (iii) an actuator coupled to the rotational shaft and enabling a rotation of the rotational shaft, the actuator being in communication with the solar panel array motion controller. In some embodiments, each one of the one or more solar panel arrays can be configured to rotate by an actuation of the actuator under control of the solar panel array motion controller, based at least in part on an instruction received by the solar panel array motion controller from the network controller.

Another aspect provided herein is a solar power generation system. In some embodiments, the system solar power generation can comprise one or more solar panel arrays, each of which comprises (i) a rotational shaft, (ii) one or more solar panels coupled to the rotational shaft and configured to rotate synchronously with the rotational shaft, and (iii) an actuator coupled to and enabling a rotation of the rotational shaft; at least one network controller; and one or more solar panel array motion controllers, each of which is provided to a respective one of the solar panel arrays and in communication with the actuator and the network controller.

In some embodiments, each one of the one or more solar panel arrays can be configured to rotate by an actuation of the actuator under control of the solar panel array motion controller, based at least in part on an instruction received by the solar panel array motion controller from the network controller. In some embodiments, the network controller can include one or more network control units (NCUs) in communication with a remote server. In some embodiments, the solar panel array motion controller can include one or more tracker control units (TCUs) configured to control the actuation of the actuator. In some embodiments, communication between the network controller and the solar panel array motion controller can be enabled by Wireless Smart Utility Network (Wi-SUN). In some embodiments, the network controller can be configured to calculate an angle adjustment to be effected by the actuator of the solar panel array, and transmit the calculated angle adjustment to the solar panel array motion controller of the solar panel array. In some embodiments, the network controller and/or the solar panel array motion controller can be configured to provide an interface for interaction with a user. In some embodiments, the actuator can be a slew drive comprising a worm shaft and a worm wheel. In some embodiments, the network controller and/or the solar panel array motion controller can be provided with a global positioning system (GPS) module. In some embodiments, the network controller and/or the solar panel array motion controller can be provided with a battery to power operation. In some embodiments, the battery can be removable. In some embodiments, the network controller and/or the solar panel array motion controller comprises a removable cover that is secured by one or more screws, and wherein the cover is configured to disposed over the battery. In some embodiments, the battery can be powered by a separate solar panel. In some embodiments, the battery can be powered by an alternating current (AC) power connection, and/or a high voltage to low voltage direct current (DC) to DC conversion system. In some embodiments, the network controller and/or the solar panel array motion controller can be provided with a sensor. In some embodiments, the sensor can comprise a wind sensor.

Still another aspect provided herein is a method for solar panel array actuation control. The method can comprise: receiving, at a solar panel array motion controller provided at a solar panel array, an instruction from a network controller to adjust a tilting angle of the solar panel array with respect to the Sun, the solar panel array comprising (i) a rotational shaft, (ii) one or more solar panels coupled to the rotational shaft and configured to rotate synchronously with the rotational shaft, and (iii) an actuator coupled to the rotational shaft and enabling a rotation of the rotational shaft, the actuator being in communication with the solar panel array motion controller; and effecting, by the actuator, a rotation of rotational shaft based at least in part on the instruction received by the solar panel array motion controller from the network controller.

Still another aspect provided herein is a method for solar panel array actuation control. The method can comprises: sending an instruction, by a network controller, to adjust a tilting angle of a solar panel array with respect to the Sun; receiving, at a solar panel array motion controller provided at the solar panel array, the instruction from the network controller, the solar panel array comprising (i) a rotational shaft, (ii) one or more solar panels coupled to the rotational shaft and configured to rotate synchronously with the rotational shaft, and (iii) an actuator coupled to the rotational shaft and enabling a rotation of the rotational shaft, the actuator being in communication with the solar panel array motion controller; and effecting a rotation of rotational shaft by an actuation of the actuator under control of the solar panel array motion controller, based at least in part on the instruction.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a schematical view illustrating an exemplary system for solar panel array actuation control in accordance with some embodiments of the disclosure.

FIG. 2 is a schematical view illustrating communication between the NCU and a TCU in accordance with some embodiments of the disclosure.

FIG. 3 is a block diagram illustrating a hardware configuration of a TCU in accordance with some embodiments of the disclosure.

FIG. 4 is a block diagram illustrating a hardware configuration of a NCU in accordance with some embodiments of the disclosure.

FIG. 5 is a block diagram outlining a software configuration for a TCU in accordance with some embodiments of the disclosure.

FIG. 6 is a block diagram outlining software components running on a NCU in accordance with some embodiments of the disclosure.

FIG. 7 illustrates an exemplary graphic interface supporting network management, which is enabled by a network management system (NMS) component at an NCU, in accordance with some embodiments of the disclosure.

FIG. 8 illustrates an exemplary graphic interface showing a system status, which is enabled by a network management system (NMS) component at an NCU, in accordance with some embodiments of the disclosure.

FIG. 9 is a perspective view illustration of an exemplary TCU in accordance with some embodiments of the disclosure.

FIG. 10 is a perspective view illustration of an exemplary NCU in accordance with some embodiments of the disclosure.

FIG. 11 schematically illustrates a computer system that is programmed or otherwise configured to implement any of the methods provided in the disclosure.

FIG. 12 is a perspective view illustration of a part of an exemplary TCU and a battery being replaced, in accordance with some embodiments.

### DETAILED DESCRIPTION

Typical solar panel array actuator systems are often assembled together from several different manufacturers and distributors, and the actuator system may be imprecise, inefficient, costly, and complex. Different manufacturers may not test their parts against other manufacturers' parts, or the communication between different parts from different manufacturers may be buggy which can lead to inefficient actuator controls. Putting together different parts can be risky as parts may not fit together well or they may not communicate well with each other. This can lead to costly and time-consuming troubleshooting which may require multiple iterations. Accordingly, there is a need for solar panel array actuator systems that are integrated ready to be installed and without the need to put together different parts.

Systems and methods for solar panel array actuation control disclosed herein can be used to control a movement of a plurality of solar trackers which are provided to a plurality of solar panels in a solar panel array. The described system may include a complete system that includes a actuator, motor, and intelligent controls in an easily integrated and commissioned package. Further, the system may be easy to install. A long-range and low-power wireless mesh network can be established with the plurality of solar trackers and a site-level controller that is in communication with the plurality of solar trackers. The site-level controller can send instructions to the individual solar tracker and collect data pertaining to a status of each individual solar tracker. The status data can be analyzed and provided to an operator via a graphic interface.

Additional benefits to an integrated solar actuation system includes utility grade self-forming and self-healing network architecture which simplifies commissioning and minimizes O&M costs. Further, an integrated solar actuation system is designed and certified to enable its users to easily meet required UL3703 standards for trackers which is critical standard and a badge of quality and bankability for tracker suppliers. Trackers can be installed in challenging and remote environments with expectations that it will work for decades.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

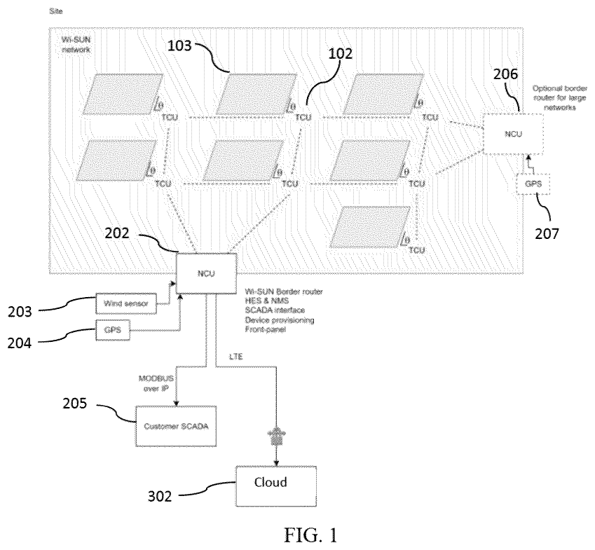

FIG. 1 is a schematical view illustrating an exemplary system for solar panel array actuation control in accordance with some embodiments of the disclosure. The system for solar panel array actuation control can comprise a network control unit (NCU) 202 and a plurality of tracker control units (TCUs) 102 which are in communication with the NCU 202. The NCU 202 can be a site-level controller. A TCU 102 can be coupled to and control an operation of an actuator of a solar panel 103 or a plurality of solar panels 103 (e.g., solar panel array) that are coupled to a common rotating shaft based on a command from the NCU 102.

The TCU 102 can be disposed adjacent to or below each solar panel 103. The TCU 102 may tilt each solar panel 103 according to angle θ based on tracking the sun's movement from east to west. In some embodiments, the TCU 102 is controlled to maximize energy production from the respective solar panels 103 as they follow or track the movement of the sun. In some embodiments, a solar tracker may configured as a single axis or a dual axis tracker. A single-axis tracker is configured to move along one axis, from east to west, typically guided by an algorithm built into the TCU 102 that adjusts its position based on the time of day and season as well as any sensed data from the coupled one or more sensors (e.g., wind sensor 203 and GPS 204). The GPS 204, 207 may provide a location of the NCU 202, 206 that is connected to the respective GPS 204, 207 and the time that the location was provided. Dual-axis trackers may be configured to move both from east to west and up and down, adjusting to the sun's changing position throughout the day and year as well as data from the one or more sensors (e.g., wind sensor 203 and GPS 204).

An example of the actuator, which drives a rotation of a solar panel along an axis, is a slew drive comprising a worm shaft and a worm wheel. In some embodiments, the slew drive used may include one or more embodiments described in co-owned International PCT Application No. PCT/US24/18959, entitled “Slew Drive”, filed on Mar. 7, 2024, which is incorporated herein by reference in its entirety for all purposes. A number of panels in a panel array can be determined based on at least one of an output torque of the actuator, a weight of a solar panel, a size of a solar panel and a size of a solar power plant. The number of panels in a panel array can be greater or equal to 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50. The number of panels in a panel array may fall within a range between any two of the values described herein. In some instances, the command for a first TCU 102 (e.g., an angle to be rotated) can be identical to the command for a second TCU 102. Optionally, the command for a first TCU 102 can be different from the command for a second TCU 102. In a single-axis solar array, one actuator can be sufficient to pivot the solar panel 103 along the east-west direction as the sun moves across the sky. In dual-axis solar arrays, two actuators may be used to allow for movement along both axes including from east to west and up and down.

The plurality of TCUs 102 can establish a long-range and low-power wireless mesh network under a certain communication protocol with the NCU 202 acting as border router. The number of TCUs 102 in the wireless mesh network per one NCU 202 as network controller can be greater than or equal to 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 510, 520, 530, 540, 550, 560, 570, 580, 590, 500, 550, 600, 650, 700, 750, 800, 850, 900, 950, or 1000. The number of TCUs 102 in a NCU-controlled network may fall within a range between any two of the values described herein. Multiple NCUs 202, 206 can add additional redundancy.

The communication between the NCU and TCUs can be implemented by a unidirectional link or bidirectional link such as Wi-Fi, 4G, 5G or LTE. An example of the communication protocol enabling the mesh network is Wi-SUN which is a mesh network protocol based on the IEEE standard 802.15.4g standard. Wi-SUN's architecture is not dependent on one base station and incorporates thousands of nodes. The standard powers large-scale outdoor IoT networks like wireless mesh networks for Advanced Metering Infrastructure (AMI), home energy management, distribution automation, and other large scale outdoor network applications including Field Area Networks (FAN) and Home Area Networks (HAN). In the mesh network under Wi-SUN's architecture, each TCU can act to talk directly to the node controller (e.g., NCU) or act as a messenger where it passes along data from other TCUs. As a result, more TCUs can increase network reliability rather than decrease it.

In some embodiments, the NCU and/or the TCU can be provided with one or more sensors. The sensors can be configured to measure an environment condition of the solar panel or detect an operational status of the solar panel. Examples of the sensors for measuring an environment condition can include a temperature sensor, a humidity sensor, a wind sensor (both wind speed and direction), a rain gauge and an air pressure sensor. Examples of the sensors for detecting an operational status of the solar panel can include an electric current/voltage sensor, an angle sensor for detecting a tilting angle of the solar panel with respect to the Sun, and a GPS sensor.

In some embodiments, a wind sensor 203 may be coupled to the NCU 202. In some embodiments, the wind sensor 203 is configured to detect real-time wind speed and real-time wind direction. The data detected by the wind sensor 203 may be used in a variety of ways. For example, the solar panels 103 may be tilted in different directions and/or angles based on the detected wind speed and wind direction. For example, if a strong wind is coming from the east to west, the solar panels 103 may be controlled to tilt towards a predetermined stow position which may include horizontal/flat, vertical, and/or angled to minimize the wind load on the solar panels. In some embodiments, as the wind speed and wind direction changes, the solar panels 103 may be tilted in different angles in order to protect the solar panels 103 and/or prevent the solar panels 103 from breaking off or other safety issue. In some embodiments, when the wind speed has been reduced below a predetermined wind speed threshold and/or the wind direction has changed to within a predetermined wind direction or range of wind directions, the solar panels 103 may be tilted back to an operating state to face the sun again so that the solar panels may be resume operation and produce energy. In some embodiments, the data from the wind sensor 203 may be provided to the cloud 302. In some embodiments, the cloud 302 corresponds to cloud computing and/or cloud storage whereby a network of computing devices that are connected over the Internet may process and/or store the data received by from the NCU 202, 206.

In some embodiments, a wireless network (e.g., a mesh Wi-SUN network described herein) formed by the TCUs over a solar array field, can provide network area access as a communications protocol/platform to third party devices. For example, other equipment, sensors (e.g., wind sensor 203 and/or GPS 204, 207), instruments or the like (e.g., used as part of a solar power plant) may access the Wi-SUN mesh network as a way to transfer information and data (that need not relate or be limited to the angular position of the solar array). Accordingly, the TCUs can be configured to offer an “open” Wi-SUN mesh which can be accessed as a source of wireless communication protocol at the site. Such “open” wireless resources can be useful and advantageous, particularly if the tracker/solar sites have poor cellular coverage.

In some embodiments, a NCU 206 can be provided as a border router to support large networks. In some embodiments, the NCU 206 can be provided with a Supervisory Control and Data Acquisition (SCADA) system 205. In some embodiments, the NCU 206 can be in communication to a SCADA system 205 via a communication link. The SCADA systems 205 can be configured to control, monitor, and analyze the data received from the individual TCUs. In some embodiments, the NCU 206 can be in communication to a cloud infrastructure 302 via a communication link (e.g., 4G, 5G or LTE), such that the received from the individual TCUs can be uploaded to a cloud server for further analysis and storage. A remote firmware updated can be enabled through communication between the TCU and the cloud server (e.g., via IEEE 1547-2018 communication). In some embodiments, a plurality of NCU 206 may be provided around the solar array to provide additional coverage. In some embodiments, one NCU 206 may be provided for every predetermined number of solar panels 103 and/or every predetermined distance. In some embodiments, an NCU 206 may be provided between rows of solar panel arrays or between a predetermined number of arrays.

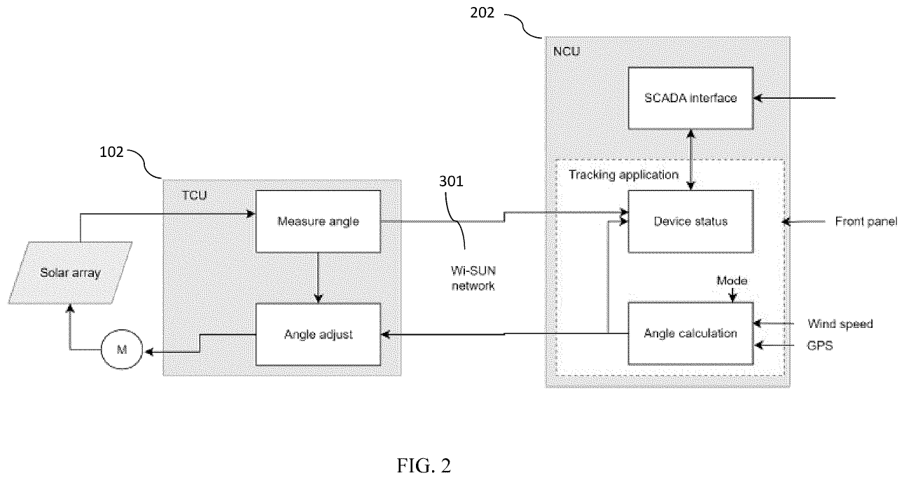

FIG. 2 is a schematical view illustrating communication between the NCU 202 and a TCU 102 via a network such as Wi-SUN network 301 in accordance with some embodiments of the disclosure. The NCU 202 can be configured to host the software components required to manage the network and control the TCUs 102. The NCU 202 can be further configured to provide an interface for the customer SCADA system. Tracking calculations can be performed on the NCU 202 at an angle calculation module. The NCU 202 can then transmit a message to the TCUs 102 to adjust the angle of their arrays. The tracking calculations can be performed based at least in part on at least one of a time in the day, a time in the year, a geographic location, a weather condition, and sensed data such as wind speed and wind direction. In some embodiments, the tracking calculations may be performed continuously such that the solar panel arrays are kept within 1 degree of the desired angle, but embodiments are not limited thereto. The arrays may be kept to any degree less than or greater than 1 degree of the desired angle.

The NCU 202 can direct individual TCU 102 to adjust their tilting angles with respect to the Sun. In some instances, the NCU 202 commands can be sent to individual TCUs 102 constantly through-out the day and/or at predetermined intervals, and/or when there is a command that needs to be relayed out of cycle (e.g., strong wind being sensed and therefore needs to command the TCUs 102 to enter a stow position. In some instances, the NCU 202 commands can be sent to individual TCUs 102 at a predetermined interval. The predetermined interval can be 1 second, 2 seconds, 5 seconds, 10 seconds, 20 seconds, 30 seconds, 40 seconds, 60 seconds, 1 minute, 2 minutes, 3 minutes, 4 minutes, 5 minutes, 6 minutes, 7 minutes, 8 minutes, 9 minutes, 10 minutes, 15 minutes, 20 minutes, 25 minutes, 30 minutes, 35 minutes, 40 minutes, 45 minutes, 50 minutes, 55 minutes or 60 minutes. The predetermined interval can be any value falling between any values listed above. In some instances, the commands from the NCU 202 can be a solar panel tilting angle adjusting command. The TCU 102 can receive the commands and execute a local control loop to adjust the tilting angles of the solar panels by actuating the solar panel actuators. For example, the TCU 102 can measure the current tilting angle of the solar panel or solar panel array, determine the angle to rotate, and actuate the actuator motor with the determined angle to rotate. In some instances, the commands from the NCU 202 can be a site-wide stow command in case of adverse weather (e.g., strong wind that can damage the solar panels). The TCUs 102 can receive the command and drive the solar panel actuators to place the panels to a safe position. In some instances, the commands from the NCU 202 can be or include a site-wide or individual maintenance command. For example, one of the NCU 202 may include a site-level controller that can command all or a subset of the NCUs 202 and/or all or subset of the TCUs 102 together. The TCUs 102 and/or the other NCUs 202 can receive the command and drive the solar panel actuators to place the panels to a maintenance position. In some embodiments, the TCUs 102 can receive data from one or more drive torque sensing systems, and process the data to determine a safe tracking position in the event that a NCU has been compromised and/or Wi-SUN communications experiencing failures. Examples of drive torque sensing systems are described in U.S. Pat. No. 11,644,084, which is incorporated herein by reference in its entirety.

In some embodiments, the Wi-SUN network 301 may include a global network protocol that enables smart and seamless connectivity across large-scale outdoor Internet of Things (IoT) applications such as TCUs, NCUs, and other components. Wi-SUN technology enables devices to communicate with each other via a mesh network. In some embodiments, Wi-SUN may utilize sub-GHz wireless frequency bands (such as 915 MHz in the US, or 868 MHz in Europe) to transmit data over long distances, which makes it more suitable for devices spread over wider geographical areas. In some embodiments, because Wi-SUN is an open standard, Wi-SUN allows for cross-vendor interoperability, meaning devices from different manufacturers can communicate with each other seamlessly. It enables easier integration and avoids vendor lock-in scenarios. Further, Wi-SUN utilizes mesh networking, where each device or node can communicate with several others within its range. If a single node fails, the mesh network can automatically reroute communications via other nodes, ensuring network robustness and reliability. Also, Wi-SUN operates in sub-GHz bands, which allows for longer-range communication compared to other wireless technologies. It also operates at low power, making it ideal for battery-powered devices such as for solar tracker systems. Wi-SUN can also support networks with millions of nodes, making it highly scalable. Wi-SUN also incorporates strong security mechanisms, including device authentication, secure key exchange, and encryption, ensuring secure communication across the network. Wi-SUN can adjust the data transmission speed according to the quality of the radio link, which can improve the overall network performance.

The Wi-SUN network 301 can enable future enhancements, including: remote wind sensors to aggregate data from across the site, wireless weather stations, extracting drive telemetry from across the system, adding wireless user interface/control units to place site information where it is convenient and safe to access. A range of coverage of each NCU node as network controller, with the Wi-SUN network 301, can be greater than or equal to about 50 meters (m), 100 m, 150 m, 200 m, 250 m, 300 m, 350 m, 400 m, 450 m, 500 m, 550 m, 600 m, 650 m, 700 m, 750 m, 800 m, 850 m, 900 m, 950 m, 1000 m, 1100 m, 1200 m, 1300 m, 1400 m, 1500 m, 1600 m, 1700 m, 1800 m, 1900 m, 2000 m, 2100 m, 2200 m, 2300 m, 2400 m, 2500 m, 2600 m, 2700 m, 2800 m, 2900 m, 3000 m, 3100 m, 3200 m, 3300 m, 3400 m, 3500 m, 3600 m, 3700 m, 3800 m, 3900 m, 4000 m, 4100 m, 4200 m, 4300 m, 4400 m, 4500 m, 4600 m, 4700 m, 4800 m, 4900 m, or 5000 m. A range of coverage of each NCU node may fall within a range between any two of the values described herein.

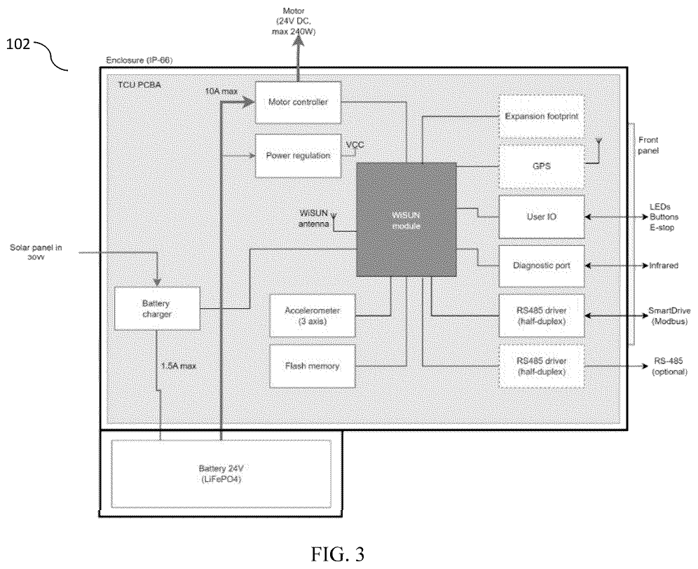

FIG. 3 is a block diagram illustrating a hardware configuration of an exemplary TCU 102 in accordance with some embodiments of the disclosure. The TCU can be configured to control the angle of a solar panel or a solar panel array by adjusting the tracker motor in response to commands received from the NCU. The tracker motor can drive an actuator to effect the desired rotation of the solar panel with a predetermined speed of rotation. An example of the actuator, which drives a rotation of a solar panel along an axis, is a slew drive comprising a worm shaft and a worm wheel. As described elsewhere herein, the slew drive may include an ST slew drive described in PCT/US24/18959. The predetermined speed of rotation of the solar panel can be about 15 deg per hour.

TCUs can also be configured to act as routers in a Wi-SUN network, creating a self-forming, resilient mesh topology between TCUs. Every TCU can be assigned an IPV6 address and connected to the head-end system (HES) for control. In some instances, a built-in antenna can be provided to the TCU. An exemplary TCU can use 900 Mhz, allowing to configure the antenna inside the enclosure to reduce additional damage prone connectors and wires. In the exemplary TCU as shown, the TCU can comprise a Wi-SUN module which is in communication with a motor controller, a Wi-SUN antenna, one or more sensors (e.g., a 3-axis accelerometer, a GPS) and a flash memory. The Wi-SUN module can act as controller to the TCU, while also providing the Wi-SUN and IP network connectivity to communicate with the Head-end system (HES). Additional serial peripheral interface (SPI) flash memory can be fitted to support over-the-air firmware updates.

In some instances, the exemplary TCU can further comprise at least one of a user I/O port, a diagnostic port and one or more communication ports (e.g., RS485 port) that communicate with the Wi-SUN module. The diagnostic port may be used by a user (e.g., technician or engineer) to plug in a diagnostic device to understand the health of the TCU, NCU, and/or system. In some embodiments, a RS485 driver may communicate with a video surveillance device or system such as SmartDrive port using a MODBUS protocol so that a user can monitor the TCU's surrounding using the video feed. One or more additional RS485 drivers may be used to communicate with other devices and/or systems. The RS485 drivers may be formed as half-duplex drivers that allow data to be transmitted in one direction at a time. However, in some embodiments, the RS485 drivers may be formed as full-duplex drivers that allow data to be transmitted in both directions simultaneously.

In some instance, a GPS chipset can be provided to each TCU, enabling a building of a reliable site network map with no user data entry required. For example, the built-in GPS can enable a technician to easily register the location of TCU, simplifying field install, commissioning and service. The GPS chipset at each TCU can also enable each TCU to track autonomously even if the NCU or the network is malfunctioned. In some instances, using benchmark industrial IoT processes, each TCU can be factory provisioned to the specific site. Once powered on, the TCU can register and configure automatically to the site, eliminating manual setups and mistakes.

In some instances, the TCU can be powered by electric power generated from a separate solar panel. A size of the separate solar panel can depend on tracker design and site irradiance. An output power of the separate solar panel can be greater than or equal to about 10 W, 15 W, 20 W, 25 W, 30 W, 35 W, 40 W, 45 W, 50 W, 55 W, 60 W, 65 W, 70 W, 75 W, 80 W, 85 W, 90 W, 95 W, 100 W, 110 W, 120 W, 130 W, 140 W, 150 W, 160 W, 170 W, 180 W, 190 W, or 200 W. The output power of the separate solar panel may fall within a range between any two of the values described herein. An exemplary output voltage and power of the separate solar panel 1001 (also known as “pony panel”) can be 24V nominal and 30 W. In some instances, a battery (e.g., a secondary battery) can be provided to the TCU to store the electric power generated from the separate solar panel. The battery can be a build-in battery. The battery can be accessible or removable from the TCU. The battery voltage can be used to power the actuator motor and other sensors. In some embodiments, the power from the separate solar panel can provide power to a battery charger circuitry that can charge the replaceable battery in the TCU 102 (e.g., battery 1210) using a 1.5 A maximum current. In some embodiments, the power for the actuator and other sensors can be from an AC hardline, and/or a high voltage to low voltage DC to DC conversion system. In some embodiments, an output of the battery may provide be regulated by a power regulation circuit.

In some instances, the TCU can be provided with a panel for displaying operational parameters and/or receiving manual input of operational parameters. The panel can be designed to be easy to operate for local control and diagnostics. Operation can be independent on the network being active, so the front panel can be active the moment the TCU is powered on, making it easy to move the system during the installation phase.

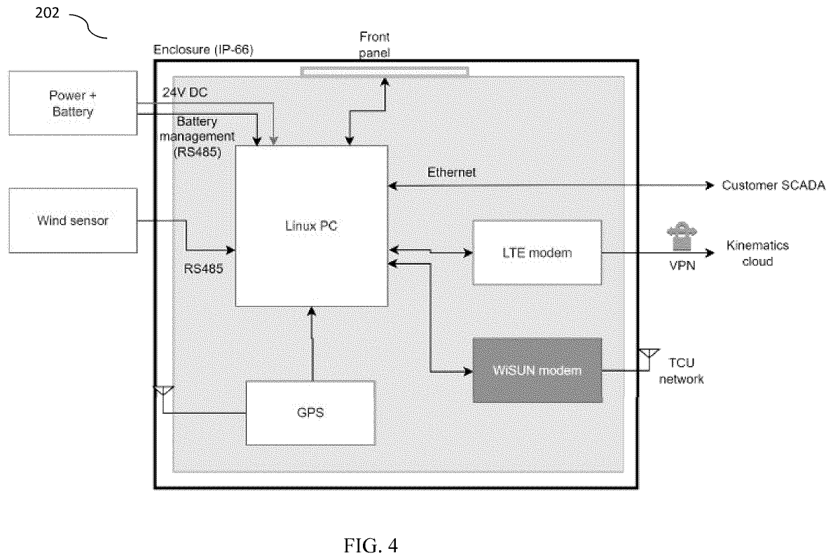

FIG. 4 is a block diagram illustrating a hardware configuration of an exemplary NCU 202 in accordance with some embodiments of the disclosure. The NCU can be configured to perform tracking calculations and command the TCUs to adjust their panels (e.g., to tilt the panels in a certain direction or to a certain angle) to optimize incident radiation. In some embodiments, the NCU can be further configured to act as an interface to the tracker control system for the client infrastructure, for example, by providing a SCADA interface to query a set of network parameters (tracking accuracy, TCU status, etc.). In some embodiments, the NCU can be further configured to host the network management software, which performs firmware updates and track Wi-SUN network performance.

In some instances, the exemplary NCU as shown can be implemented with an industrial computer (e.g., a central processing unit such as a Linux PC), equipped with a communication module (e.g., an LTE modem) to provide a remote diagnostic and data retrieval interface, a Wi-SUN modem that provides connectivity to the wireless network, and a GPS chipset that provides time and location data. In some embodiments, the GPS chipset of FIG. 4 may be the same as the GPS 204, 207 of FIG. 1. In some instances, the NCU can be powered by electric power generated from a separate solar panel (e.g., panel 1001, a 24V solar panel). In some instances, a battery (e.g., a secondary battery) can be provided to store the electric power generated from the separate solar panel. The industrial computer can read various sensor data, for example, a wind speed from a local wind sensor that is described herein. An ethernet connection to the customer SCADA system can also be provided. A front panel can provide basic status indication and controls. In some instance, a user can manually input parameters for NCU via the front panel. For larger networks (e.g., more than 100 TCUs), additional border routers can be required. These devices can be similar to the NCU hardware as shown.

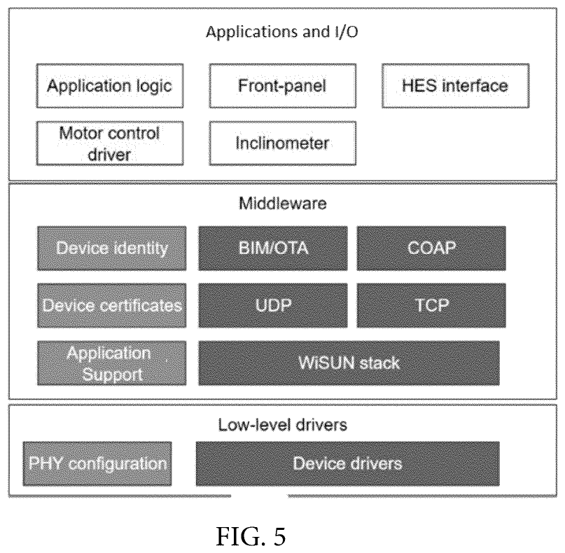

FIG. 5 is a block diagram outlining a software architecture for TCU 102 in accordance with some embodiments of the disclosure. In some embodiments, the software architecture may include at least three different layers. In some embodiments, the lowest layer may include the physical layer that includes low-level drivers. The drivers may include device drivers that are communicated via a physical communication medium such as cabling, wires, air, etc. In some embodiments, a middleware layer may be formed over the physical layer and include one or more of device identity module, device certificates module, application support module, boot image manager (BIM)/over the air (OTA) module, user datagram protocol (UDP) module, constrained application protocol (COAP) module, transmission control protocol (TCP) module, and Wi-SUN stack. In some embodiments, a plurality of applications may be programmed or formed over the middleware and include application logic and HES interface. One or more input and output (I/O) devices and/or protocols may be connected to the applications as well, including a front panel where the user can interact with the TCU, a motor control driver to drive the actuator, and an inclinometer to measure the angle of tilting.

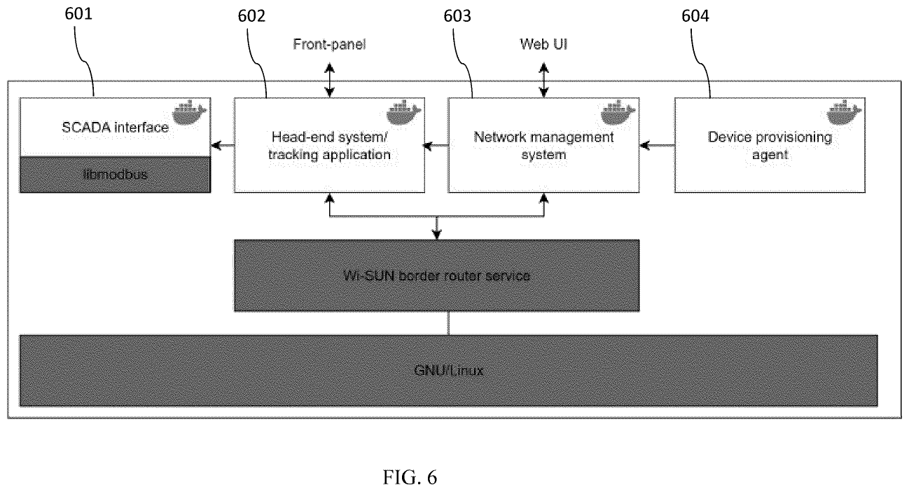

FIG. 6 is a block diagram outlining a software components running on a NCU in accordance with some embodiments of the disclosure. As shown, the NCU can be configured to host at least one of software components such as a SCADA interface 601. a head-end system (tracking application) (HES) 602, a network management system (NMS) 603 and a device provisioning agent 604.

In some embodiments, the NCU can offer a summarized view of the status of the system to the customer SCADA system through a communication protocol like MODBUS over the SCADA interface 601. This can allow the customer to monitor and integrate the tracker control system into their own backend.

In some embodiments, adjusting solar arrays to track the sun can be implemented by the tracking application (a head-end system) 602. Tracking calculations can be performed continuously or at a predetermined interval, to keep arrays within 1 degree of the desired angle as discussed elsewhere herein. Basic back-tracking can be supported to optimize power generated at low incident light angles. In some instances, a local wind sensor can be monitored to detect when the wind speed exceeds a safe threshold (after filtering), and the NCU can command the TCUs to stay in the stow position while this holds true.

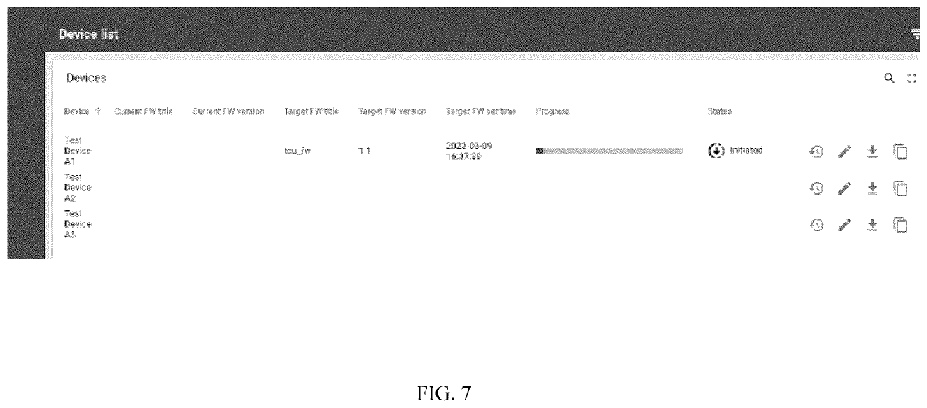

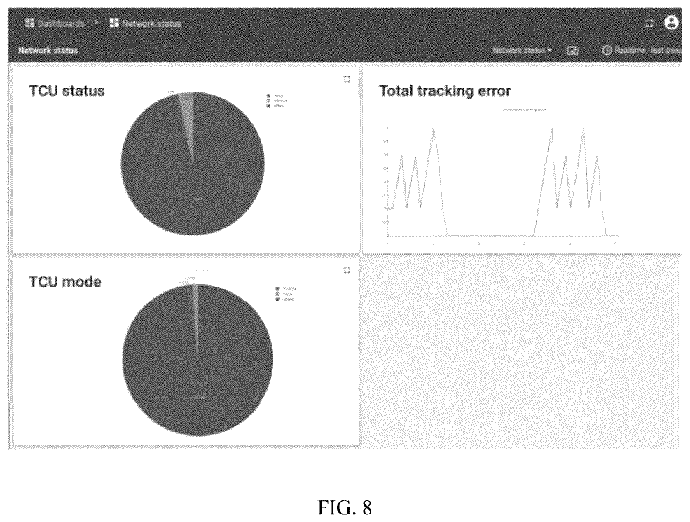

In some embodiments, the network management system (NMS) component 603 can be configured to be responsible for the basic network management functionality of the system, including but not limited to: adding and removing devices to/from the network, viewing TCU status information, viewing NCU status information, and perform firmware updates. In some instances, a web interface can be provided to support these operations, as well as to support remote operations and diagnostics. For example, a firmware update view may look similar to FIG. 7, showing device details, firmware details and update status as it progresses. In some embodiments, the NCU can be configured to offer a summarized view of the status of the system to the customer SCADA system through a MODBUS over IP interface. This can allow the customer to monitor and integrate the tracker control system into their own backend. A system status overview can be represented graphically, to summarize the selected indicators of system performance. For example, as illustrated in FIG. 8, the dashboard can show the status of TCUs on the network (active, offline or unheard), the tracking mode of all drives in the system, and a performance metric (sum of set angle vs. measured angle over all devices).

In some embodiments, to install a TCU, the TCU identification number (ID) and the location of the solar array are to be associated with each other. To minimize installation costs and sources of error, this association should be frictionless to the installation technician. This can be facilitated by the device provisioning agent 604. The device provisioning agent can be configured to receive an installation notification, which specifies either the location of the TCU or the array ID, which can be associated with each other. The device provisioning agent can then notify the HES and NMS of the TCU parameters. This can be initially compatible with manual data entry, but can facilitate progress to automated device provisioning using, e.g., using a mobile device where feasible.

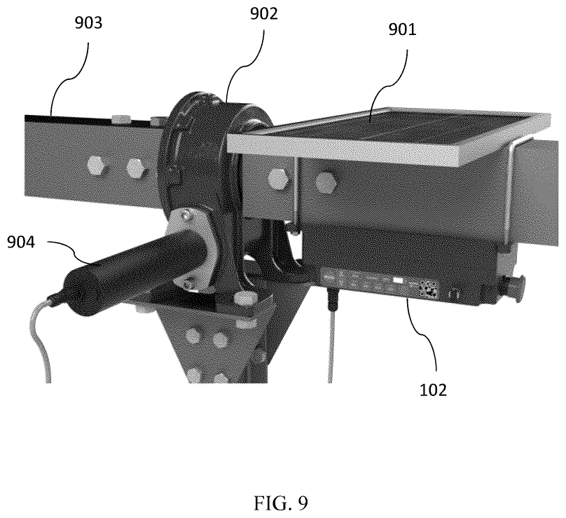

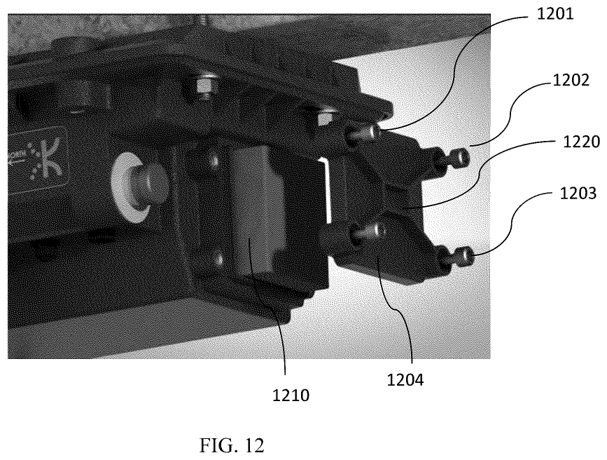

FIG. 9 is a perspective view illustration of an exemplary TCU in accordance with some embodiments of the disclosure. The TCU 102 can be powered by an electric power generated from a separate solar panel 901 (e.g., a 24V nominal, 30 W solar panel). In some instances, a secondary battery can be provided to the TCU to store the electric power generated from the separate solar panel. The battery can be accessible or removable from the TCU as described with respect to FIG. 12. The battery voltage can be used to power the motor 904 of the actuator 902. An example of the actuator, which drives a rotation of a solar panel array which are rigidly coupled to a common rotational shaft 903, is a slew drive comprising a worm shaft and a worm wheel. The TCU 102 can be coupled to the common bearing bar of the solar panel array at a position in proximity to the actuator. The rotation control signal can be transmitted from the TCU 102 to motor 904 of the actuator 902 via a cable or via a wireless communication link. A torque (e.g., backwards holding torque) output from the actuator can be greater than or equal to about 5 kN·m (kilonewton meter), 10 kN·m, 15 kN·m, 20 kN·m, 25 kN·m, 30 kN·m, 35 kN·m, 40 kN·m, 45 kN·m, 50 kN·m, 55 kN·m, 60 kN·m, 65 kN·m, 70 kN·m, 75 kN·m, 80 kN·m, 85 kN·m, 90 kN·m, 95 kN·m, 100 kN·m, 110 kN·m, 120 kN·m, 130 kN·m, 140 kN·m, 150 kN·m, 160 kN·m, 170 kN·m, 180 kN·m, 190 kN·m or 200 kN·m. The torque output from the actuator may be fall within a range between any two of the values described herein. A real-time automatic tracker damage protection can be provided to avoid an over torque event. Examples of drive torque sensing systems for real-time automatic tracker damage protection, are described in U.S. Pat. No. 11,644,084 which is incorporated herein by reference in its entirety.

As used herein, the term “motor” may refer to, or include a gear motor. In the example of FIG. 9, the motor 904 may be an electrical motor (either brushed or brushless) coupled with a planetary reducer (e.g., a 3 to 4 stage gear stacking with a total reduction around 300:1), before entering into the slew drive through the motor adapter and the two hex mounting bolts.

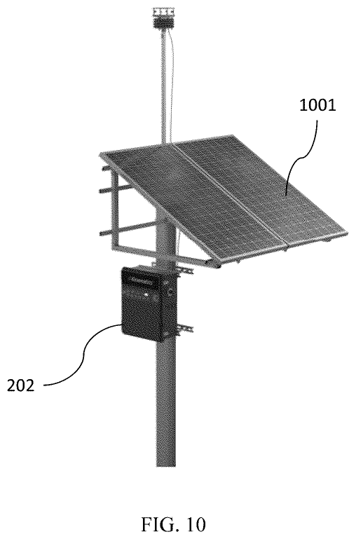

FIG. 10 is a perspective view illustration of an exemplary NCU 202 in accordance with some embodiments of the disclosure. In some instances, the NCU 202 can be disposed at a height above the ground to provide an optimal signal coverage in communication with TCUs. The NCU 202 can be powered by an electric power generated from a separate solar panel 1001. In some instances, a secondary battery can be provided to the NCU to store the electric power generated from the separate solar panel.

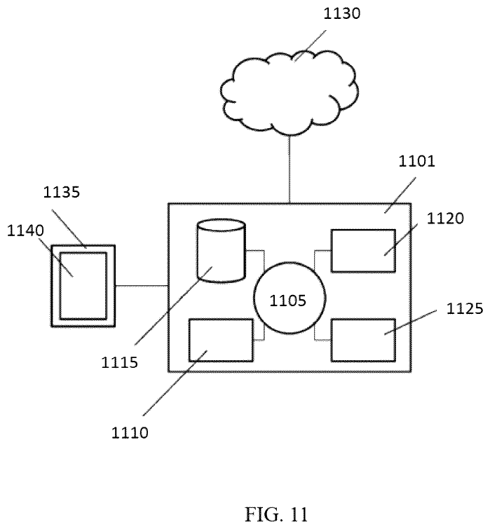

The present disclosure provides a computer system that is programmed to implement methods and systems of the disclosure. FIG. 11 schematically illustrates a computer system that is programmed or otherwise configured to implement any of the methods provided in the disclosure. The computer system 1101 can regulate various aspects of the present disclosure, such as, for example, controlling ion gating components and rendering graphical user interfaces and the other functions as described elsewhere herein. The computer system 1101 can be an electronic device of a user or a computer system that is remotely located with respect to the electronic device. The electronic device can optionally be a mobile electronic device.

The computer system 1101 includes a central processing unit (CPU, also “processor” and “computer processor” herein) 1105, which can be a single core or multi core processor, or a plurality of processors for parallel processing. The computer system 1101 also includes memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet and/or extranet, or an intranet and/or extranet that is in communication with the Internet.

The network 1130 in some cases is a telecommunication and/or data network. The network 1130 can include one or more computer servers, which can enable distributed computing, such as cloud computing. For example, one or more computer servers may enable cloud computing over the network 1130 (“the cloud”) to perform various aspects of analysis, calculation, and generation of the present disclosure, such as, for example, capturing a configuration of one or more experimental environments; performing usage analyses of products (e.g., applications); and providing outputs of statistics of projects. Such cloud computing may be provided by cloud computing platforms such as, for example, Amazon Web Services (AWS), Microsoft Azure, Google Cloud Platform, and IBM cloud. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases can include one or more additional data storage units that are external to the computer system 1101, such as located on a remote server that is in communication with the computer system 1101 through an intranet or the Internet.

The computer system 1101 can communicate with one or more remote computer systems through the network 1130. For instance, the computer system 1101 can communicate with a remote computer system of a user (e.g., a user of an experimental environment). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1101 via the network 1130.

Methods as described herein can be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, the various components (e.g., lab, launch pad, control center, knowledge center, etc.) of the model management system. Examples of UI's include, without limitation, a graphical user interface (GUI) and web-based user interface.

Referring to FIG. 12, the battery 1210 of a TCU or NCU may be easily removed and replaced from the TCU, in accordance with some embodiments. For example, TCU may include a compartment where the battery 1210 may be inserted and removed from one side of the TCU. The battery may be protected by a cover 1220 that may be placed over the battery. The cover 1220 may secure the battery in place for powering the TCU. In some embodiments, as shown in FIG. 12, the cover may be secured to the body or housing of the TCU with four screws 1201, 1202, 1203, 1204. The four screws may be untightened to release the cover 1220 from the TCU and tightened to secure the cover 1220 over the battery. By having an easily replaceable battery 1210, the TCU may be easily maintained by different personnel that own or operate the solar panel array and actuation system, without an expert technician to physically go to the site.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A system for solar panel array actuation control, the system comprising:
at least one network controller; and
one or more solar panel array motion controllers provided to a one or more solar panel arrays, wherein the one or more solar panel array motion controllers are in wireless communication with the at least one network controller,
wherein each solar panel array of the one or more solar panel arrays comprises (i) a rotational shaft, (ii) one or more solar panels coupled to the rotational shaft and configured to rotate synchronously with the rotational shaft, and (iii) an actuator coupled to the rotational shaft and configured to enable a rotation of the rotational shaft, the actuator being in communication with a solar panel array motion controller of the one or more solar panel array motion controllers, and
wherein each solar panel array is configured to rotate by an actuation of the actuator under control of the solar panel array motion controller, based at least in part on an instruction received by the solar panel array motion controller from the network controller.

2. The system of claim 1, wherein the network controller comprises a network control unit (NCU) in communication with a remote server.

3. The system of claim 1, wherein the solar panel array motion controller comprises a tracker control unit (TCU) configured to control the actuation of the actuator.

4. The system of claim 1, wherein communication between the network controller and the one or more solar panel array motion controllers is enabled by Wireless Smart Utility Network (Wi-SUN).

5. The system of claim 1, wherein the network controller is configured to calculate an angle adjustment to be effected by the actuator of at least one of the one or more solar panel arrays and transmit the calculated angle adjustment to the solar panel array motion controller of the at least one of the one or more solar panel arrays.

6. The system of claim 1, wherein the network controller and/or the one or more solar panel array motion controllers are configured to provide an interface for interaction with a user.

7. The system of claim 1, wherein the actuator comprises a slew drive comprising a worm shaft and a worm wheel.

8. The system of claim 1, wherein the network controller and/or the one or more solar panel array motion controllers are provided with a GPS module.

9. The system of claim 1, wherein the network controller and/or the one or more solar panel array motion controllers are provided with a battery to power an operation thereof.

10. The system of claim 9, wherein the battery is removable.

11. The system of claim 10, wherein the network controller and/or the one or more solar panel array motion controllers comprise a removable cover that is secured by one or more screws, and wherein the cover is configured to be disposed over the battery.

12. The system of claim 9, wherein the battery is powered by a separate solar panel.

13. The system of claim 1, wherein the network controller and/or the one or more solar panel array motion controllers are provided with a sensor.

14. The system of claim 13, wherein the sensor comprises a wind sensor.

15.-32. (canceled)

33. The system of claim 1, wherein the instruction received by the solar panel array motion controller from the network controller comprises instructions to adjust a tilting angle of the solar panel array with respect to a sun position.

34. The system of claim 1, wherein the one or more network controllers are configured to collect status data from at least one of the one or more solar panel array motion controllers.

35. The system of claim 34, wherein the one or more network controllers are configured to analyze the status data and provide a result to a user via a display.

36. The system of claim 1, wherein the one or more solar panel array motion controllers comprise single axis trackers configured to move from east to west and vice versa based on one or more of a time of day, a season, or sensed data.

37. The system of claim 1, wherein the one or more solar panel array motion controllers comprise dual axis trackers configured to move east to west and up and down based on a sun position during the day, a sun position during a season, sensed data, or any combination thereof.

38. The system of claim 37, further comprising a second actuator in solar panel arrays controlled by dual axis trackers.
